(19) United States
(12) Patent Application Publication
(10) Pub. No.: US 2008/0023106 A1
(43) Pub. Date: Jan. 31, 2008

(54) The Professional Portable Mitre Saw Bench

(76) Inventor: David Owen Baker, Toccoa, CA (US)

Correspondence Address: DAVID OWEN BAKER, 4120 WEST CURRAHEE STREET, TOCCOA, CA, 30577, US

(21) Appl. No.: 11/460,986

(22) Filed: Jul. 30, 2006

(51) Int. Cl. B25H 1/00; B27B 27/06; B27B 5/18; B23D 19/00

(52) U.S. Cl. 144/286.5; 83/471.3

(57) ABSTRACT

The Professional Portable Mitre Saw Bench was conceived for the purposes of utilising a Mitre Saw on a work site faster. This saw bench was also designed to be lightweight and weatherproof.

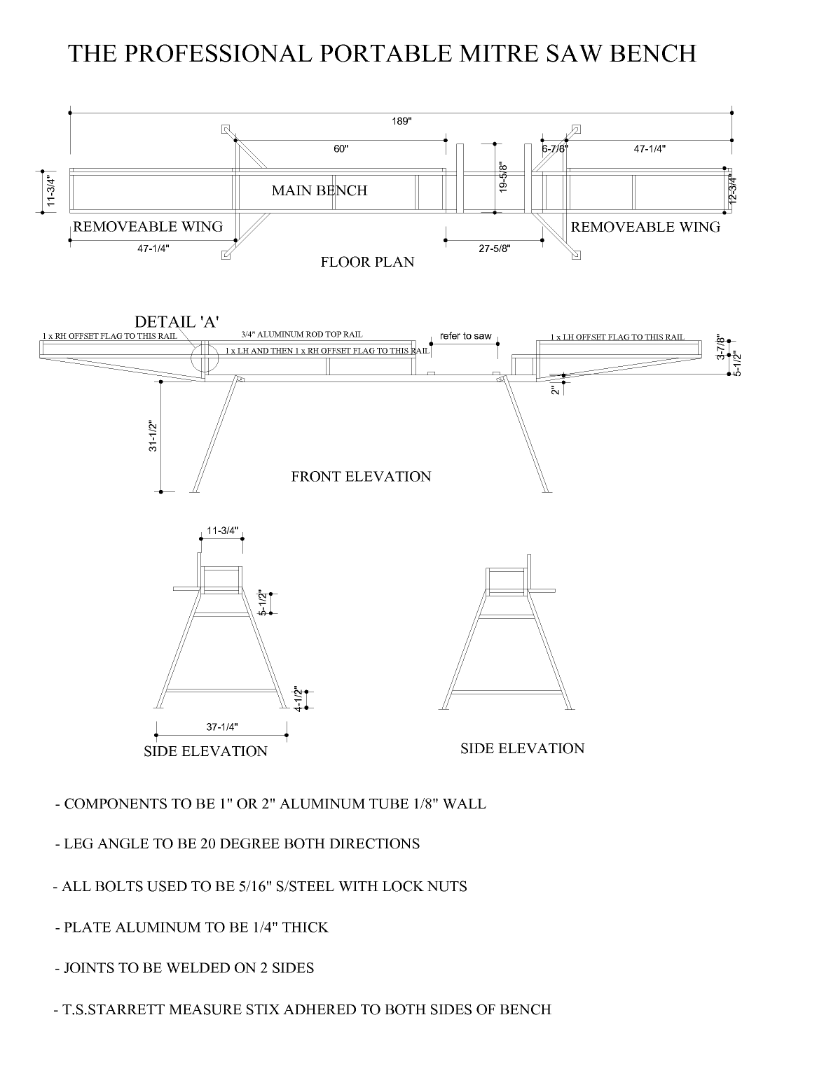

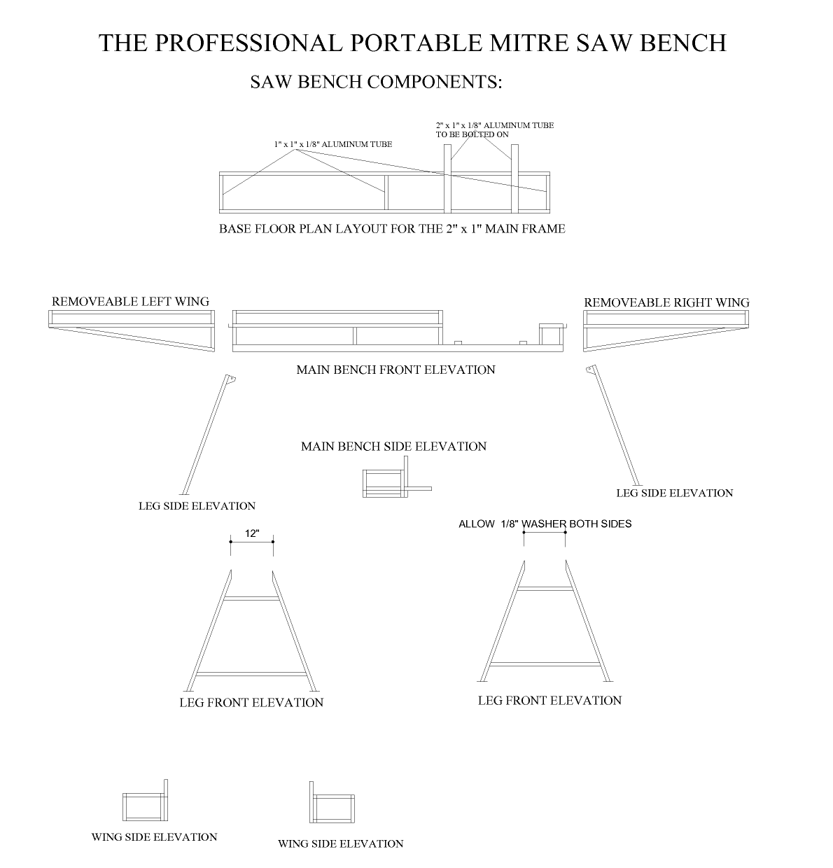

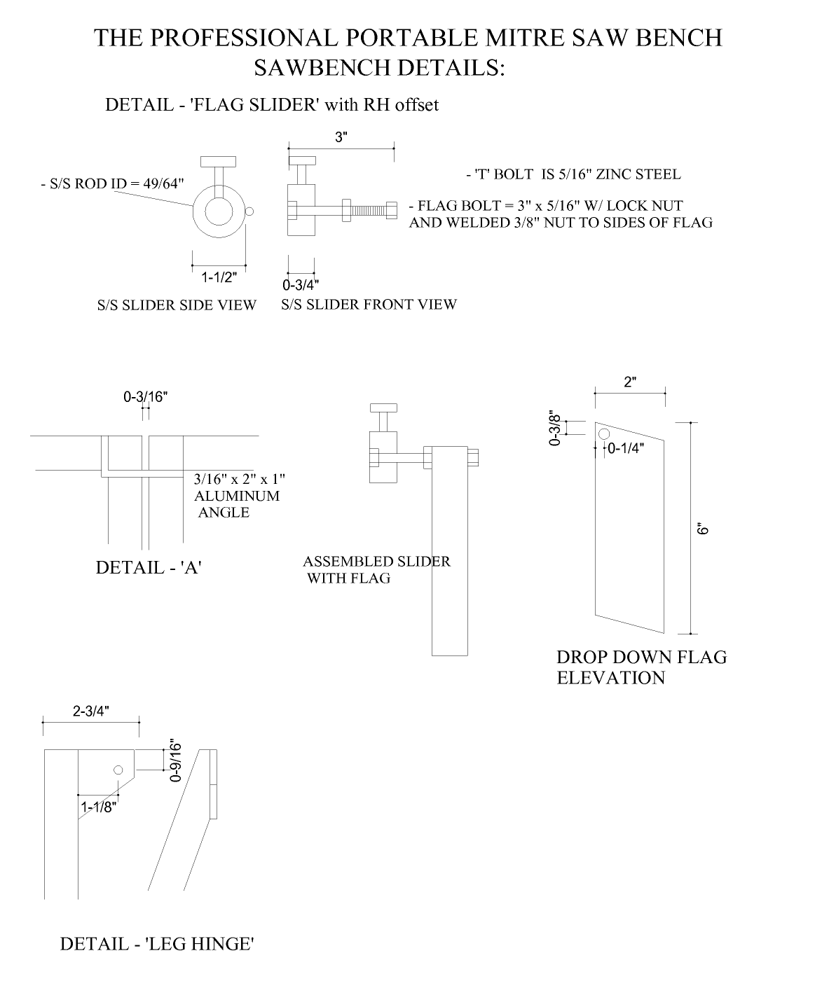

A measuring tape affixed to the bench in both directions from the Mitre Saw allows a piece of lumber to be placed on the bench, up to the desired measurement and cut without the need to produce a tape measure or pencil.

The ‘Slider and Flag’ that are run along a rail above the measuring tape on the bench are designed to expedite accurately repeated lumber cuts. The ‘Flag’ pivots on a bolt on the slider to rise when not needed and lowered when it is. The ‘Slider’ that the flag is attached to is moveable along the rail to get to the position needed for repeat cuts. The result is a simply designed fast cutting Saw bench.

### SPECIFICATIONS

This substitute Specification replaces the Specification submitted in the original application (application Ser. No. 11/460,986 filed on Jul. 30, 2006), written 21^{st} Jul. 2006. This substitute specification only adds a description of the drawings submitted in the original application (application Ser. No. 11/460,986 filed on Jul. 30, 2006), no new matter has been added.

### DRAWING DESCRIPTION

Sawpage1 drawing shows a scaled FLOOR PLAN of the Saw Bench. The view is looking directly down over the bench, showing its width and length. The three (3) main components are labelled.

Sawpage1 shows a scaled FRONT ELEVATION of the bench. This view is looking at the bench from in front of it, showing its height and length. ‘Detail-A’ is noted as an enlargement on Sawpage3. The ‘Slider and Flags’ as detailed on Sawpage3 are indicated here for the purpose of position, handing and number of them. The opening in the bench where a Mitre Saw would sit is shown with a measurement labelled ‘refer to saw’ for the purpose of varying the width of the support rails to suit various Mitre Saws. Four (4) S/S bolts as detailed on this drawing are fixed pointing upward in the support rails to secure the Mitre Saw base from movement whilst on the bench. The legs shown in this view are hinged as detailed on Sawpage3 & fold inwards to meet the underside of the main bench.

Sawpage1 shows a scaled SIDE ELEVATION of the bench. This view is looking at both ends of the bench with the legs opened outwards.

Sawpage1 lists the materials used in the bench components; the leg angles; type of bolts; joint fixing method and measuring tape used.

Sawpage2 shows the breakdown of the components of the bench. These components are: main bench, left wing, right wing, left leg and right leg.

Sawpage2 shows the layout of the main bench base. This is the primary support for the wings and the Mitre Saw.

Sawpage3 drawing shows details noted on Sawpage1 of ‘Detail-A’ and the ‘Slider and Flag’. The leg hinge is also shown, which is bolted as described on Sawpage1.

The detailed ‘Slider and Flag’ on Sawpage3 is the mechanism for which adjustable positions are utilised in repeat cuts at varying opportunities with the Mitre Saw.

Materials: 6063 T52 Aluminum tubing
Standard grade S/S rod
Standard grade S/S bolts, nuts and washers

Weight: Main bench is 50 lb finished with legs
Wings are 10 lb each
Total bench weight is 70 lbs.

Size: Length—fully assembled—189 inches
packed up—97 inches
Width—38 inches
Height—fully assembled—43 inches
packed up—13 inches

1. No other Portable Mitre Saw bench has a 10 foot and 6 foot fixed tape No other Portable Mitre Saw bench has adjustable Sliding Flags No other Portable Mitre Saw bench can do quick repeat or one off cuts
